(19) United States
(12) Patent Application Publication
(10) Pub. No.: US 2008/0033822 A1
(43) Pub. Date: Feb. 7, 2008

(54) SYSTEMS AND METHODS FOR FILTERING ONLINE ADVERTISEMENTS CONTAINING THIRD-PARTY TRADEMARKS

(75) Inventor: Richard Merdinger, Coralville, IA (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 11/866,831

(22) Filed: Oct. 3, 2007

(51) Int. Cl. G06Q 30/00

(52) U.S. Cl. 705/14

(57) ABSTRACT

Systems and methods of the present invention allow for filtering online advertisements containing third-party trademarks. In an example embodiment, a webpage host may host a webpage that resolves from a domain name. A check trademark service may parse the domain name into a keyword that an advertising generator may use to generate an advertisement relevant to the keyword. Before the advertisement is generated, however, the check trademark service may download a list of registered trademarks from a trademark database into local storage and determine whether the subject keyword is trademarked by searching the downloaded list of trademarks for the keyword. If the keyword is present, the process may end. Otherwise, the advertising service may generate an advertisement for publication on the webpage. This process may be repeated if the domain name is parsed into more than one keyword.

### FIELD OF THE INVENTION

The present inventions generally relate to the field of online advertising and, more specifically, systems and methods for filtering online advertisements containing third-party trademarks.

### BACKGROUND OF THE INVENTION

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as websites. The combination of all the websites and their corresponding webpages on the Internet is generally known as the World Wide Web (WWW) or simply the Web.

Websites may be created using HyperText Markup Language (HTML) to generate a standard set of tags that define how the webpages for the website are to be displayed. Users of the Internet may access content providers' websites using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user. The user then may view other webpages at the same website or move to an entirely different website using the browser.

Browsers are able to locate specific websites because each website on the Internet has can be uniquely identified through the combination of an Internet Protocol (IP) address, a port, and/or a hostname. Each IP address is a 32 bit binary number, but is typically shown in dotted decimal notion (e.g., 192.145.68.112) to improve human readability. IP addresses, however, even in dotted decimal notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. Otherwise, the Internet user may keep selecting alternative domain names until an available domain name is found. Domain names are typically registered for a period of one to ten years with first rights to continually re-register the domain name.

Applicant has noticed that domain name registrants often post advertisements on webpages that resolve from their domain names (i.e., appear when the domain name is entered in a browser). Often these advertisements relate in some way to the registrant's domain name and include trademarks to which the registrant has no rights. For the foregoing reasons, there is a need for systems and methods for filtering online advertisements containing third-party trademarks.

### SUMMARY OF THE INVENTION

The limitations cited above and others are substantially overcome through the systems and methods disclosed herein, which allow for filtering online advertisements containing third-party trademarks.

In an example embodiment, a webpage host may host a webpage that resolves from a domain name. A check trademark service may parse the domain name into a keyword that an advertising generator may use to generate an advertisement relevant to the keyword. Before the advertisement is generated, however, the check trademark service may download a list of registered trademarks from a trademark database into local storage and determine whether the subject keyword is trademarked by searching the downloaded list of trademarks for the keyword. If the keyword is present, the process may end. Otherwise, the advertising service may generate an advertisement for publication on the webpage. This process may be repeated if the domain name is parsed into more than one keyword.

An exemplary system includes a webpage hosted by a webpage host; a trademark database having a plurality of trademarks; a check trademark service to determine the absence of a keyword in said trademark database; an advertising generator generating an advertisement relevant to said keyword; an advertisement publisher publishing said advertisement on said webpage; and a network communicatively coupling said webpage host, said trademark database, said check trademark service, said advertising generator, and said advertising publisher.

An exemplary method of practicing the present invention may include the steps of receiving a keyword; searching a trademark database for said keyword; if said keyword is not found in said trademark database, generating an advertisement relevant to said keyword; and publishing said advertisement on a webpage. Among other things, the keyword could be a search term entered in a search engine, a parsed domain name, a parsed webpage content, or a parsed advertisement. The searching step may be accomplished by downloading a list of trademarks from a trademark database into local storage and searching the list for the keyword. The trademark databases to be searched may include USPTO databases (including TESS/TARR), databases maintained by any third party (e.g., individuals, entities companies, foreign nations, states, and/or the World Intellectual Property Organization (WIPO)), and/or a blacklist generated by a user. In addition to generating and publishing the advertisement locally, the advertisement may be received from—and/or published by—a third party advertising service.

The above features and advantages of the present invention will be better understood from the following detailed description taken in conjunction with the accompanying drawings.

### BRIEF DESCRIPTION OF THE DRAWINGS

FIG. 1 illustrates a possible embodiment of a system for filtering online advertisements containing third-party trademarks.

FIG. 2 illustrates a possible embodiment of a system for filtering online advertisements containing third-party trademarks.

FIG. 3 illustrates possible embodiments of a network.

FIG. 4 illustrates possible embodiments of a trademark database.

FIG. 5 illustrates a possible embodiment of a system for filtering online advertisements containing third-party trademarks.

FIG. 6 illustrates a possible embodiment of a system for filtering online advertisements containing third-party trademarks.

FIG. 7 illustrates possible embodiments of a keyword.

FIG. 8 is a flow diagram illustrating a possible embodiment of a method for filtering online advertisements containing third-party trademarks.

FIG. 9 is a flow diagram illustrating a possible embodiment of a method for filtering online advertisements containing third-party trademarks.

FIG. 10 is a flow diagram illustrating a possible embodiment of a method for filtering online advertisements containing third-party trademarks.

FIG. 11 is a flow diagram illustrating a possible embodiment of a method for filtering online advertisements containing third-party trademarks.

FIG. 12 is a flow diagram illustrating a possible embodiment of a method for filtering online advertisements containing third-party trademarks.

FIG. 13 is a flow diagram illustrating a possible embodiment of a method for filtering online advertisements containing third-party trademarks.

FIG. 14 is a flow diagram illustrating a possible embodiment of a method for filtering online advertisements containing third-party trademarks.

FIG. 15 is a flow diagram illustrating a possible embodiment of a method for filtering online advertisements containing third-party trademarks.

### DETAILED DESCRIPTION

The present inventions will now be discussed in detail with regard to the attached drawing figures which were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

After a customer registers a domain name, but before a fully-developed website is generated, he may post a temporary webpage that resolves from his domain name (i.e., appears when his domain name is entered in a browser). The temporary webpage may state “under construction,” “coming soon,” “this domain was registered,” “for sale,” etc. These webpages are often provided to the customer by the registrar and may appear until such time that the customer replaces the temporary webpage with a functional website. Such temporary webpages without substantive content may be referred to as “parked” webpages, meaning the domain name is parked and awaiting further action (e.g., creating a website).

While the domain name is “parked,” the domain name registrant may participate in a program that allows domain name registrants, registrars, and advertisers to jointly monetize the parked webpage by providing advertisements for the webpage. This practice is generally known as “domain parking,” which works as follows. An advertising service (e.g., GOOGLE) maintains a database of advertisers who specify keywords that relate to their advertisements. The advertisers pay the advertising service for inclusion in the database. A registrar (e.g., GODADDY.COM) may partner with the advertising service to provide advertising content on its customer's parked webpages. When Internet users access the parked webpage and click on an advertisement, the advertising service pays the registrar a fee, which may be shared with the domain name registrant. This advertising model is known as “pay per click.” Examples of such programs include GODADDY.COM CASHPARKING, GOOGLE ADSENSE AND ADWORDS, YAHOO! SEARCH MARKETING, and MICROSOFT ADCENTER. Usually, the domain owner and the registrar share in the profits paid by the advertising service based on how many links have been visited (e.g., pay per click) and on how beneficial those visits have been.

The parked webpage advertisements are often targeted to the predicted interests of Internet users who access the webpage. To accomplish this, the advertising service's advertisement generation software may parse the parked domain name into keywords, and generate content based upon those keywords. For example, if the domain name “greencelery.com” is parked, the temporary webpage may include advertisements and/or links for products or services related to the keywords “green” and/or “celery.” Advertisers specify the keywords that should trigger their ads and bid on such keywords to obtain priority over competitors.

Individuals, companies, and other entities that provide content on the Web generally want to use their name or one of their trademarks as part of their domain name. Thus, domain names are often company trademarks, personal names, or short phrases concatenated with a top level domain name (TLD) extension (e.g., .com, .net, .org, .biz, .us, .cc, .ws, .de, etc.). The domain name “godaddy.com” is one such example. However, a registrant may register a domain name that incorporates a third parties' trademark (e.g., mygodaddy.com). Although the trademark owner may take legal action to recover ownership of such a domain name, often the trademark owner is unaware of the potentially infringing domain name. There will always be a period of time (before the trademark owner obtains legal relief) during which the potentially-infringing domain name is not under the trademark owner's control.

In such situations, an unscrupulous domain name registrant may attempt to financially gain from using the trademarked domain name. For example, he may sign up for one of the domain parking advertising methods discussed above. If the trademark owner is one of the advertisers partaking in the advertising program (many major products and services providers are), the trademark owner's advertisements and links may appear when an Internet user accesses the domain name registrant's parked webpage. Using the hypothetical example in the previous paragraph, if an Internet user accesses a parked webpage resolving from a domain name that includes a trademark (but is not owned or controlled by the trademark owner—such as www.mygodaddy.com), the trademark owner and legitimate business entity's (GODADDY.COM) advertisements and links may appear. Legitimate trademark owners may not want their trademarks, advertisements, links, and websites used in such a manner because it allows others to profit from their trademarks. Such practices also may add credence or an air of legitimacy to any products or services offered on the domain name registrant's webpage.

For these reasons, systems and methods for filtering online advertisements containing third-party trademarks are needed.

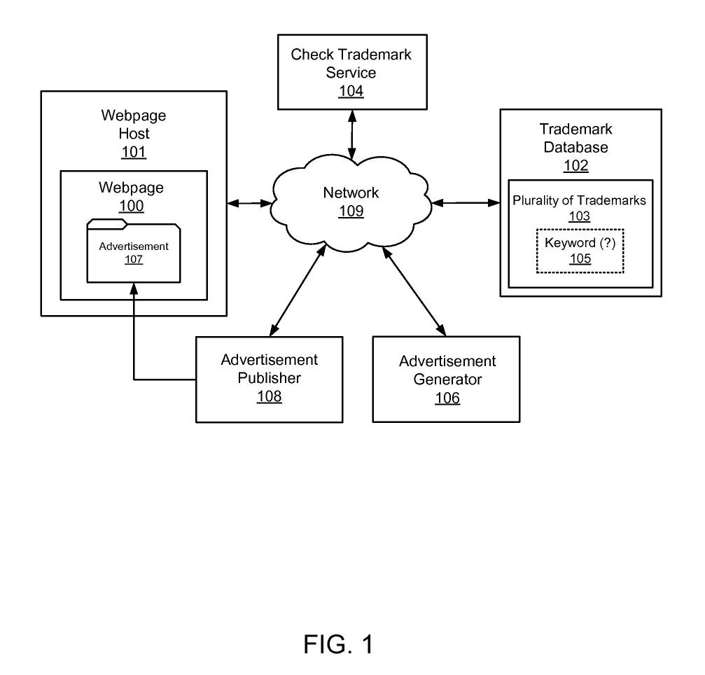

An example embodiment of a system for filtering online advertisements containing third-party trademarks is illustrated in FIG. 1. The illustrated embodiment includes a webpage 100 hosted by a webpage host 101; a trademark database 102 having a plurality of trademarks 103; a check trademark service 104 to determine the absence of a keyword 105 in said trademark database 102; an advertising generator 106 generating an advertisement 107 relevant to said keyword 105; an advertisement publisher 108 publishing said advertisement 107 on said webpage 100; and a network 109 communicatively coupling said webpage host 101, said trademark database 102, said check trademark service 104, said advertising generator 106, and said advertising publisher 108.

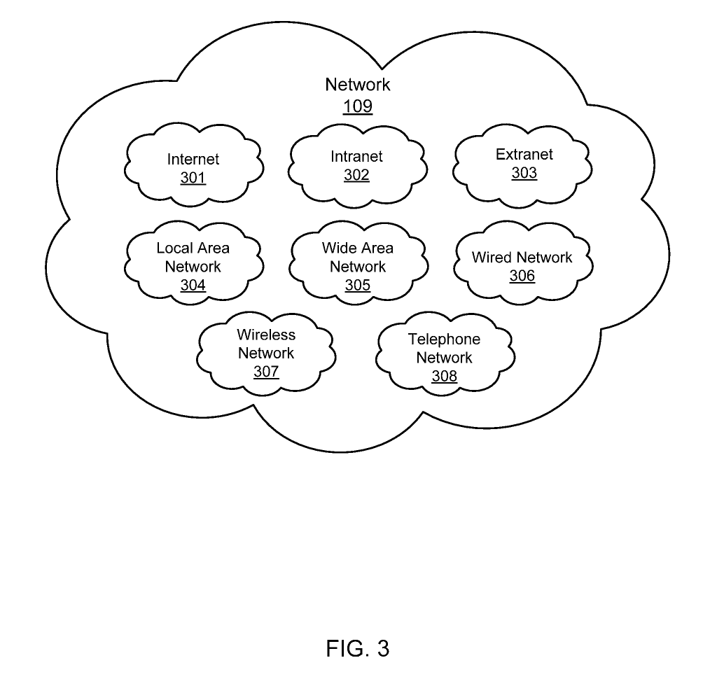

The embodiments illustrated herein place no limitation on network 109 configuration or connectivity. Thus, as non-limiting examples—and as illustrated in FIG. 3—the network 109 could comprise the Internet 301, an intranet 302, an extranet 303, a local area network 304, a wide area network 305, a wired network 306, a wireless network 307, a telephone network 308, or any combination thereof. The network 109 may utilize dedicated connections between the webpage host 101 and trademark database 102. As a non-limiting example, a hub service may be used to improve communications by attempting to keep open one or more secure connections, possibly via a Secure Socket Layer (SSL) connection. Alternatively, a connection admission control protocol may be use to limit, restrict, or otherwise govern such connections.

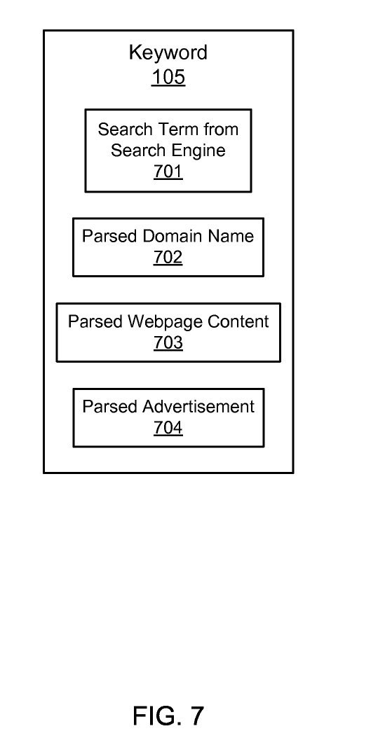

As non-limiting examples—and as illustrated in FIG. 7—the keyword 105 may be derived from a search term entered in a search engine 701, a parsed domain name 702, a parsed webpage content 703 (e.g., terms and/or images appearing on a webpage), or a parsed advertisement 704 (e.g., terms and/or images appearing in an advertisement). As is well known in the art, parsing is the process of analyzing a sequence of tokens to determine its grammatical structure with respect to a given formal grammar. Parsing transforms input text into a data structure, a keyword here. With the instant inventions, text may be parsed using any parsing methodology known in the art including, but not limited to, top-down parsing and/or bottom-up parsing. The parsing process also may include glyph or character substitution (i.e., identifying typographically improper characters and substituting characters that result in potentially-meaningful keywords). For example, the parsing process may replace the “0” in the domain name, “g0daddy.com” with an “o,” resulting in more effective keyword parsing because “go” is more likely a valid keyword than “g0.”

The webpage host 101 may comprise any entity that hosts a webpage including, but not limited to, a domain name registrar, registry, or reseller, a hosting service provider, an internet service provider, an advertising service, a search entity (including, but not limited to, any entity offering Internet, intranet, website, local or wide-area search engine functionality), a server, and/or a client.

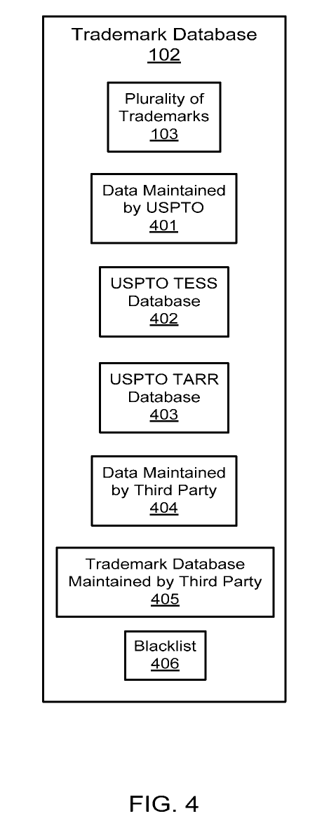

The trademark database 102 may comprise any collection of data that includes a plurality of trademarks 103, which may be registered trademarks, unregistered trademarks, common-law trademarks, valid and enforceable trademarks, and/or invalid and unenforceable trademarks. The trademark database 102 need not be a complete collection of registered trademarks to function within the purview of the present invention. As illustrated in FIG. 4, the trademark database 102 may comprise data maintained by the USPTO 401, the USPTO TESS database 402, the USPTO TARR database 403, a collection of data maintained by a third party 404, and/or a trademark database maintained by a third party 405. Such third parties may include individuals, entities companies, foreign nations, states, and/or the World Intellectual Property Organization (WIPO). The trademark database 102 also may comprise a blacklist 406 including trademarks determined to be precluded from use in online advertising. A system user may manually manage the blacklist 406 by adding or deleting trademarks. Alternatively, the system may automatically update the blacklist 406 by adding trademarks to the blacklist 406 that have been otherwise filtered from use (e.g., found in the trademark database 102).

Structurally, the trademark database 102 may comprise any collection of data. As non-limiting examples, the trademark database 102 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage located on a computer, client, server, or other storage device.

The check trademark service 104 may comprise search software that determines if at least one keyword 105 is present in the trademark database 102. This search may be accomplished by any data search mechanism known in the art including, but not limited to, desktop, network, or online search engines and may utilize, among others, uninformed, list, tree, graph, SQL, tradeoff based, informed, adversarial, constraint satisfaction, string, genetic, sorting, probabilistic, tabu, federated, minimax, and/or ternary search algorithms. The check trademark service 104 may, via the network 109, directly access the trademark database 102 and search for the keyword 105.

The advertisement generator 106 then may—for each keyword 105 not found in the trademark database 102—generate an advertisement 107 relevant to the keyword 105 and, via an advertisement publisher 108, return the advertisement 107 to the webpage host 101 for publication on the webpage 100. The advertisement publisher 108 may comprise any means of publishing an advertisement known in the art including, but not limited to, computer-implemented software for posting data on a website. The advertisement 107 may comprise any form of online advertising including, but not limited to, text, graphics, video, and/or audio data. The advertisement 107 also could comprise a hyperlink to another website, another website, and/or both. Among other types, the advertisement 107 may be a pop-up, pop-under, banner, contextual, targeted, and/or focused ad that relates in some manner to the keyword 105. For example, if greencelery.com is the subject domain name, it may be parsed into the keywords “green” and/or “celery.” The advertisement generator 106 then may generate advertisements and/or links for products or services related to the keywords “green” and/or “celery,” such as advertisements for a farm stand, produce distributor, or a store having a sale on green paint. The advertisement generator 106 may comprise a third party advertisement generating service such as GOOGLE ADSENSE AND ADWORDS, YAHOO! SEARCH MARKETING, or MICROSOFT ADCENTER or it may be a proprietary service. The advertisement 107 may be published by the advertising publisher 108 on a webpage 100 hosted by the webpage host 101 or any other webpage.

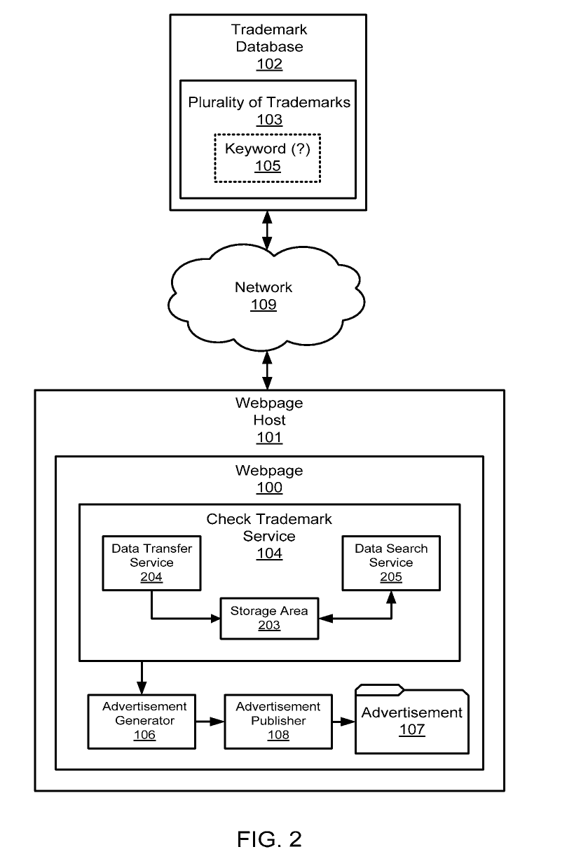

Another example embodiment of a system for filtering online advertisements containing third-party trademarks is illustrated in FIG. 2. The illustrated embodiment includes a webpage 100 hosted by a webpage host 101; a trademark database 102 having a plurality of trademarks 103; a check trademark service 104 to determine the absence of a keyword 105 in said trademark database 102; an advertising generator 106 generating an advertisement 107 relevant to said keyword 105; an advertisement publisher 108 publishing said advertisement 107 on said webpage 100; and a network 109 communicatively coupling said webpage host 101, said trademark database 102, said check trademark service 104, said advertising generator 106, and said advertising publisher 108. As illustrated in this example embodiment, the check trademark service 102 may utilize a data transfer service 204 to download a plurality of data from the trademark database 102 (that may include the plurality of trademarks 103 and/or additional data) to a storage area 203 located within the check trademark service (e.g., a client or server's hard drive or other storage media).

The data transfer service 204 may communicate with the trademark database 102 via the network 109 and may utilize any method of transferring data known in the art. Such methods can generally be classified in two categories: (1) “pull-based” data transfers where the receiver initiates a data transmission request; and (2) “push-based” data transfers where the sender initiates a data transmission request. Both types are expressly included in the Applicant's intended definition of “data transfer service 204,” which also may include transparent data transfers over network file systems, explicit file transfers from dedicated file-transfer services like FTP or HTTP, distributed file transfers over peer-to-peer networks, file transfers over instant messaging systems, file transfers between computers and peripheral devices, and/or file transfers over direct modem or serial (null modem) links, such as XMODEM, YMODEM and ZMODEM. Data streaming technology also may be used to effectuate data transfer. A data stream may be, for example, a sequence of digitally encoded coherent signals (packets of data) used to transmit or receive information that is in transmission. Any data transfer protocol known to those skilled in the art may be used including, but not limited to: (1) those used with TCP/IP (e.g., FTAM, FTP, HTTP, RCP, SFTP, SCP, or FASTCopy); (2) those used with UDP (e.g., TFTP, FSP, UFTP, or MFTP); (3) those used with direct modem connections; (4) HTTP streaming; (5) Tubular Data Stream Protocol (TDSP); (6) Stream Control Transmission Protocol (SCTP); and/or (7) Real Time Streaming Protocol (RTSP).

A data search service 205 may perform the keyword search locally, perhaps using the search techniques discussed above. Prior to searching, the downloaded data may be optimized for improved searchability. Such optimization may be accomplished by parsing the downloaded data to extract the trademarks, which may be stored in the storage area 203. Searches conducted on the optimized file may be accomplished faster than searching the entire trademark database 102. Such searches are also faster since they occur locally, rather than distally though the network 109. The check trademark service 104 also may be conducted by a third party that returns search results to the webpage host 101 and/or advertisement generator 106, possibly via the network 109.

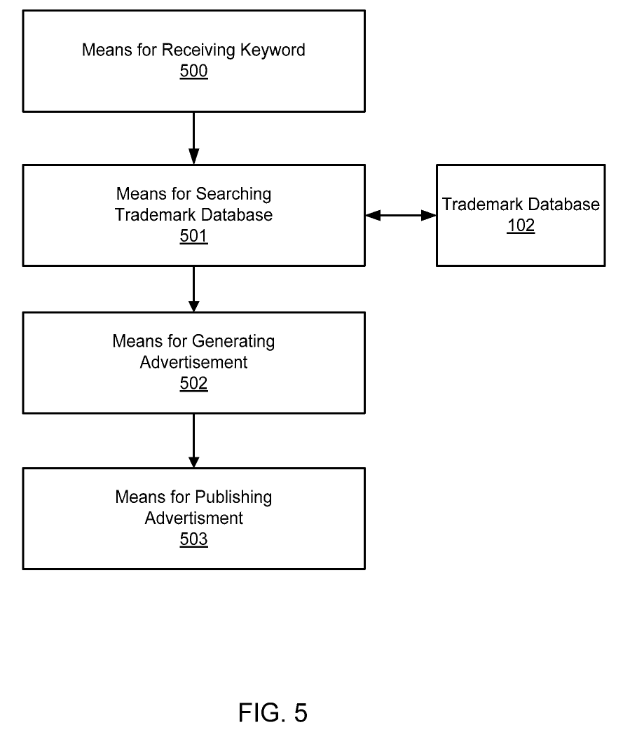

A streamlined example embodiment of a system for filtering online advertisements containing third-party trademarks is illustrated in FIG. 5. The illustrated embodiment includes a trademark database 102; means for receiving a keyword 500; means for searching a trademark database for said keyword 501; means for generating an advertisement relevant to said keyword if said keyword is not found in said trademark database 502; and means for publishing said advertisement on a webpage 503.

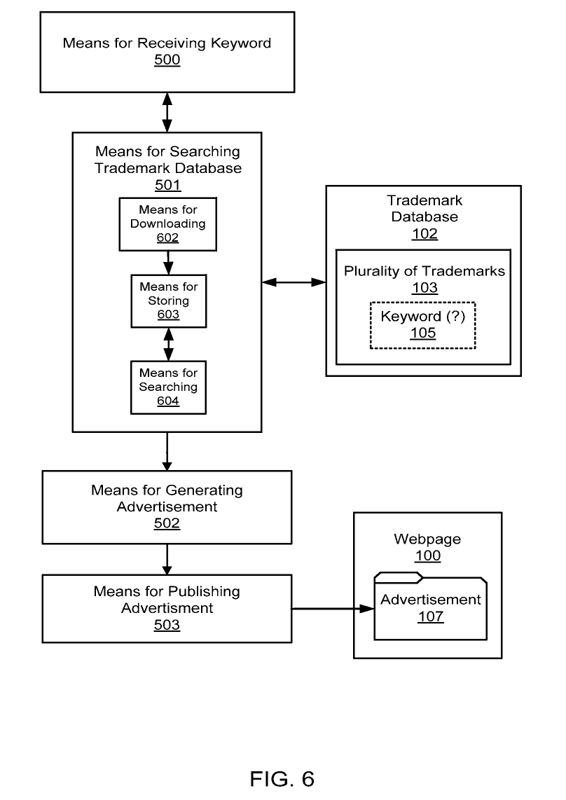

A more detailed example embodiment of a system for filtering online advertisements containing third-party trademarks is illustrated in FIG. 6. The illustrated embodiment includes a trademark database 102 having a plurality of trademarks 103; means for receiving a keyword 500; means for searching a trademark database for said keyword 501; means for generating an advertisement relevant to said keyword 502 (if said keyword is not found in said trademark database); and means for publishing 503 said advertisement on a webpage 503. The means for searching the trademark database 501 may comprise means 602 for downloading data from the trademark database 102, means 603 for storing the data, and means 604 for searching the data for a keyword 105.

As non-limiting examples, the means for receiving a keyword 500 may comprise deriving a keyword 105 from a search term entered in a search engine 701, parsing a domain name 702, parsing webpage content 703 (e.g., terms and/or images appearing on a webpage), parsing an advertisement 704 (e.g., terms and/or images appearing in an advertisement), and/or parsing any data into keywords. As is well known in the art, parsing is the process of analyzing a sequence of tokens to determine its grammatical structure with respect to a given formal grammar. Parsing transforms input text into a data structure, a keyword here. With the instant inventions, text may be parsed using any parsing methodology known in the art including, but not limited to, top-down parsing and/or bottom-up parsing. The parsing process also may include glyph or character substitution (i.e., identifying typographically improper characters and substituting characters that result in potentially-meaningful keywords). For example, the parsing process may replace the “0” in the domain name, “g0daddy.com” with an “o,” resulting in more effective keyword parsing because “go” is more likely a valid keyword than “g0.”

The means for searching the trademark database 501 may comprise search software that determines if at least one keyword 105 is absent in the trademark database 102. This search may be accomplished by any data search mechanism known in the art including, but not limited to, desktop, network, or online search engines and may utilize, among others, uninformed, list, tree, graph, SQL, tradeoff based, informed, adversarial, constraint satisfaction, string, genetic, sorting, probabilistic, tabu, federated, minimax, and/or ternary search algorithms. The means for searching the trademark database 501 may, via a network 109, directly access the trademark database 102 and search for the keyword 105.

Alternatively, the means for searching the trademark database 501 may utilize means 602 for downloading data from the trademark database 102 to a means for storing data 603 (e.g., a client or server's hard drive, magnetic drive, temporary memory, flash memory, or other storage media) located within the means for searching the trademark database 501. The means 602 for downloading may utilize any method of transferring data known in the art. Such methods can generally be classified in two categories: (1) “pull-based” data transfers where the receiver initiates a data transmission request; and (2) “push-based” data transfers where the sender initiates a data transmission request. Both types are expressly included in the Applicant's intended definition of “data transfer service 204,” which also may include transparent data transfers over network file systems, explicit file transfers from dedicated file-transfer services like FTP or HTTP, distributed file transfers over peer-to-peer networks, file transfers over instant messaging systems, file transfers between computers and peripheral devices, and/or file transfers over direct modem or serial (null modem) links, such as XMODEM, YMODEM and ZMODEM. Data streaming technology also may be used to effectuate data transfer. A data stream may be, for example, a sequence of digitally encoded coherent signals (packets of data) used to transmit or receive information that is in transmission. Any data transfer protocol known to those skilled in the art may be used including, but not limited to: (1) those used with TCP/IP (e.g., FTAM, FTP, HTTP, RCP, SFTP, SCP, or FASTCopy); (2) those used with UDP (e.g., TFTP, FSP, UFTP, or MFTP); (3) those used with direct modem connections; (4) HTTP streaming; (5) Tubular Data Stream Protocol (TDSP); (6) Stream Control Transmission Protocol (SCTP); and/or (7) Real Time Streaming Protocol (RTSP).

A means for searching the downloaded data 604 then may perform the keyword 105 search locally, perhaps using the search techniques discussed in detail above. Prior to searching, the downloaded data may be optimized for improved searchability. Such optimization may be accomplished by parsing the downloaded data to extract the trademarks, which may be stored in a separate file in the storage means 603. Searches conducted on the optimized file may be accomplished faster than searching the entire trademark database 102. Such searches are also faster since they occur locally, rather than distally though a network 109. The means for searching 501 also may be conducted by a third party that conducts the search and returns search results, perhaps to the means for generating an advertisement 502, possibly via a network 109.

The means for generating an advertisement 502 may generate an advertisement 107 relevant to the keyword 105 if the keyword 105 is not found in said trademark database 102. The means for generating an advertisement 502 may scan the text of a webpage for keywords, obtain keywords from a search engine, or parse a domain name into keywords, and return an advertisement 107 to the webpage 100 that is relevant to the keyword 105. Among other types, the advertisement 107 may be a pop-up, pop-under, banner, contextual, targeted, and/or focused ad that relates in some manner to the keyword 105. For example, if greencelery.com is the subject domain name, it may be parsed into the keywords “green” and/or “celery.” The means for generating an advertisement 502 then may generate advertisements and/or links for products or services related to the keywords “green” and/or “celery,” such as an advertisement for a farm stand, produce distributor, or a store having a sale on green paint. The means for generating an advertisement 502 may comprise a third party, possibly an advertisement generating service such as GOOGLE ADSENSE AND ADWORDS, YAHOO! SEARCH MARKETING, or MICROSOFT ADCENTER or it may be a proprietary service. The advertisement 108 may be published by the means for publishing an advertisement 503 on a webpage 100 or any other advertising media.

Alternatively, the keyword filtering function may be performed after the means for generating an advertisement 502 generates an advertisement 107. This embodiment, which may incorporate any of the structures described above, may be particularly beneficial to any entity that subscribes to a third party advertising generation service, such as GOOGLE ADSENSE AND ADWORDS, YAHOO! SEARCH MARKETING, or MICROSOFT ADCENTER. This structure allows for the filtering of an incoming advertisement 107 that may or may not include a third-party trademark after the advertisement 107 is generated. With this embodiment, the searching means 501 may scan the text of the advertisement 107 for a keyword 105 that needs to be checked against the trademark database 102.

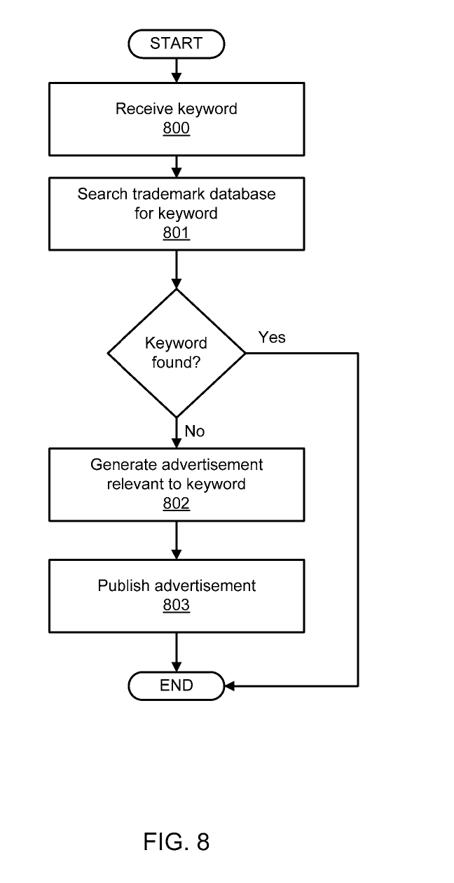

Several different methods may be used for filtering online advertisements containing third-party trademarks. In an example embodiment illustrated in FIG. 8, a keyword 105 may be received (Step 800). This embodiment places no limitations on the source of the keyword 105. As non-limiting examples—and as illustrated in FIG. 7—the keyword 105 may be derived from a search term entered in a search engine 701, parsing a domain name 702, parsing webpage content 703 (e.g., terms and/or images appearing on a webpage), or a parsing an advertisement 704 (e.g., terms and/or images appearing in an advertisement). As is well known in the art, parsing is the process of analyzing a sequence of tokens to determine its grammatical structure with respect to a given formal grammar. Parsing transforms input text into a data structure, a keyword here. With the instant inventions, text may be parsed using any parsing methodology known in the art including, but not limited to, top-down parsing and/or bottom-up parsing. The parsing process also may include glyph or character substitution (i.e., identifying typographically improper characters and substituting characters that result in potentially-meaningful keywords). For example, the parsing process may replace the “0” in the domain name, “g0daddy.com” with an “o,” resulting in more effective keyword parsing because “go” is more likely a valid keyword than “g0.”

A trademark database 102 then may be searched for the keyword (Step 801). This search may be accomplished via a dedicated connection to the trademark database 102. As a non-limiting example, a hub service may be used to improve communications by attempting to keep open one or more secure connections, possibly via a Secure Socket Layer (SSL) connection. A connection admission control protocol may also be used to limit, restrict, or otherwise govern such connections. An advertisement 107 then may be generated relevant to the keyword 105 if the keyword 105 is not found in the trademark database 102 (Step 802). The advertisement 107 then may be published on a webpage 100 (Step 803).

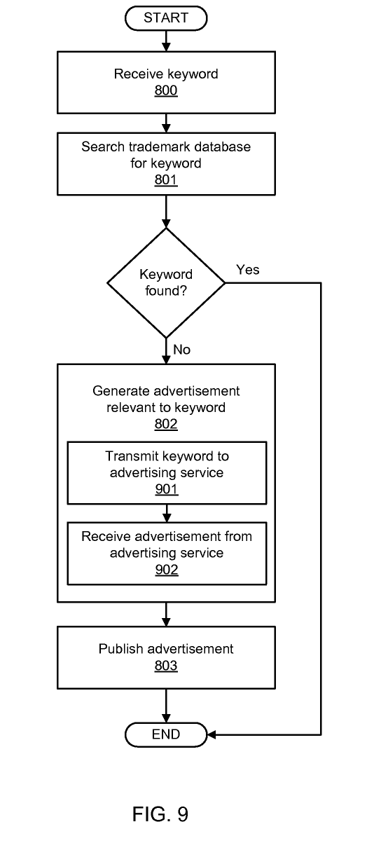

Another example embodiment of a method for filtering online advertisements containing third-party trademarks is illustrated in FIG. 9. In this example embodiment, a keyword 105 may be received (Step 800) and a trademark database 102 then may be searched for the keyword 105 (Step 801). An advertisement 107 then may be generated relevant to the keyword 105 if the keyword 105 is not found in the trademark database 102 (Step 802). In this embodiment, the advertisement 107 may be generated by transmitting the keyword 105 to a third-party advertising service, such as GOOGLE ADSENSE AND ADWORDS, YAHOO! SEARCH MARKETING, or MICROSOFT ADCENTER (Step 901). An advertisement 107 is then received back from the advertisement service (Step 902) and published on a webpage 100 (Step 803).

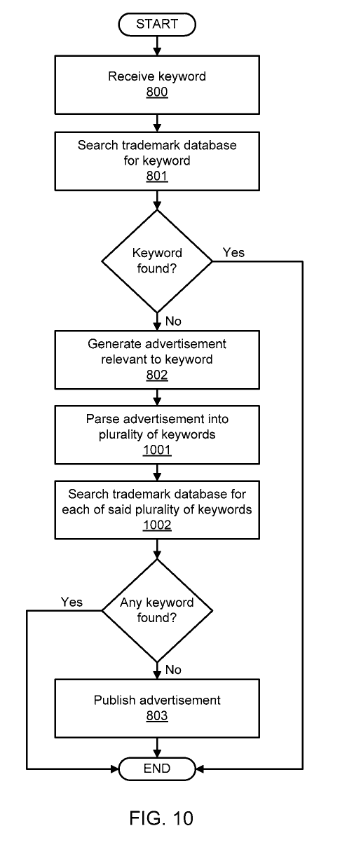

Another embodiment of a method for filtering online advertisements containing third-party trademarks is illustrated in FIG. 10. In this embodiment, which re-filters an advertisement 107 once generated, a keyword 105 is received (Step 800) and a trademark database 102 is searched for the keyword 105 (Step 801). An advertisement 107 is then generated relevant to the keyword 105 if the keyword 105 is not found in the trademark database 102 (Step 802). The advertisement 107 is then parsed into a plurality of keywords (Step 1001) perhaps using the parsing techniques discussed elsewhere in this application. The plurality of keywords may be generated from the content of the advertisement 107 (e.g., terms, links, and/or images appearing in the advertisement). The trademark database 102 is then searched for each of the plurality of keywords (Step 1002). If none of the plurality of keywords are found in the trademark database 102, the advertisement 107 is published on a webpage 100 (Step 803). The second filtering step addresses the contingency that an advertisement 107 containing a third-party trademark may be generated from a trademark-filtered keyword. For example, using the generic keyword “truck” may result in advertisements for a trademarked manufacturer's name, such as FORD or CHEVROLET. The instant embodiment reduces this possibility.

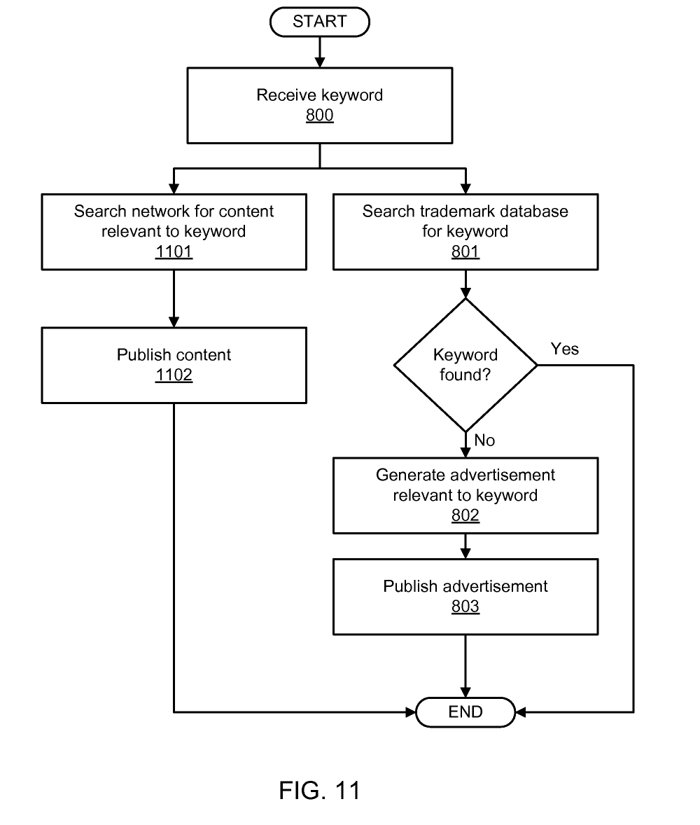

In another embodiment illustrated in FIG. 11, a keyword 105 may be received (Step 800). A network 109 then may be searched for content relevant to the keyword 105 (Step 1101). The embodiments illustrated herein place no limitation on network 109 configuration or connectivity. Thus, as non-limiting examples—and as illustrated in FIG. 3—the network 109 could comprise the Internet 301, an intranet 302, an extranet 303, a local area network 304, a wide area network 305, a wired network 306, a wireless network 307, a telephone network 308, or any combination thereof. The network 109 may be searched with any search engine known in the art and may use any of the search methodologies discussed above. The relevant content then may be published (Step 1102), perhaps via hyperlinks on a webpage 100. Concurrent with the above-described network content search, a trademark database 102 also may be searched for the keyword (Step 801). An advertisement 107 then may be generated relevant to the keyword 105 if the keyword 105 is not found in the trademark database 102 (Step 802). The advertisement 107 then may be published on the webpage 100 (Step 803) along with the above described content.

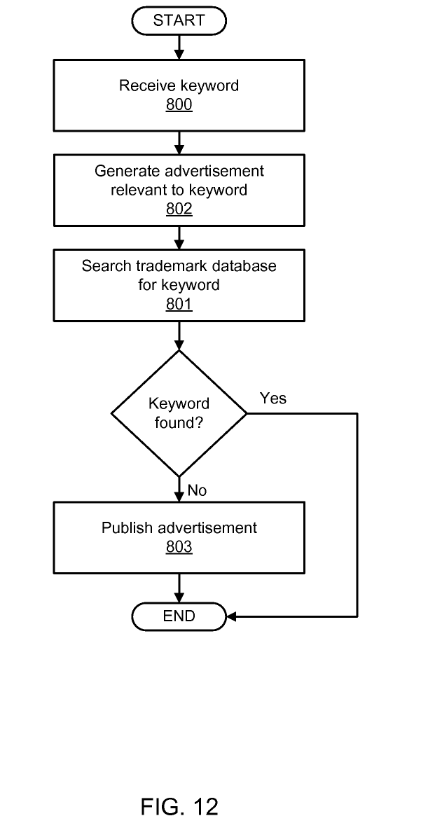

FIGS. 12 through 15 illustrate methods for filtering online advertisements containing third-party trademarks wherein the initial keyword filtering function is performed after an advertisement 107 is generated. These embodiments, which may incorporate many of the steps described above, may be particularly beneficial to any entity that subscribes to a third party advertising generation service, such as GOOGLE ADSENSE AND ADWORDS, YAHOO! SEARCH MARKETING, or MICROSOFT ADCENTER. These methods allow for the filtering of an incoming advertisement 107 that may or may not include a third-party trademark. With these embodiments, the text of the advertisement 107 may be scanned for a keyword 107 that needs to be checked against the trademark database 102.

In an example embodiment illustrated in FIG. 12, a keyword 105 may be received (Step 800). This embodiment places no limitations on the source of the keyword 105. As non-limiting examples—and as illustrated in FIG. 7—the keyword 105 may be derived from a search term entered in a search engine 701, parsing a domain name 702, parsing webpage content 703 (e.g., terms and/or images appearing on a webpage), or a parsing an advertisement 704 (e.g., terms and/or images appearing in an advertisement). As is well known in the art, parsing is the process of analyzing a sequence of tokens to determine its grammatical structure with respect to a given formal grammar. Parsing transforms input text into a data structure, a keyword here. With the instant inventions, text may be parsed using any parsing methodology known in the art including, but not limited to, top-down parsing and/or bottom-up parsing. The parsing process also may include glyph or character substitution (i.e., identifying typographically improper characters and substituting characters that result in potentially-meaningful keywords). For example, the parsing process may replace the “0” in the domain name, “g0daddy.com” with an “o,” resulting in more effective keyword parsing because “go” is more likely a valid keyword than “g0.”

An advertisement 107 then may be generated relevant to the keyword 105 (Step 802). A trademark database 102 then may be searched for the keyword (Step 801). This search may be accomplished via a dedicated connection to the trademark database 102. As a non-limiting example, a hub service may be used to improve communications by attempting to keep open one or more secure connections, possibly via a Secure Socket Layer (SSL) connection. A connection admission control protocol may also be used to limit, restrict, or otherwise govern such connections. If the keyword 105 is not found in the trademark database 102, the advertisement 107 then may be published on a webpage 100 (Step 803).

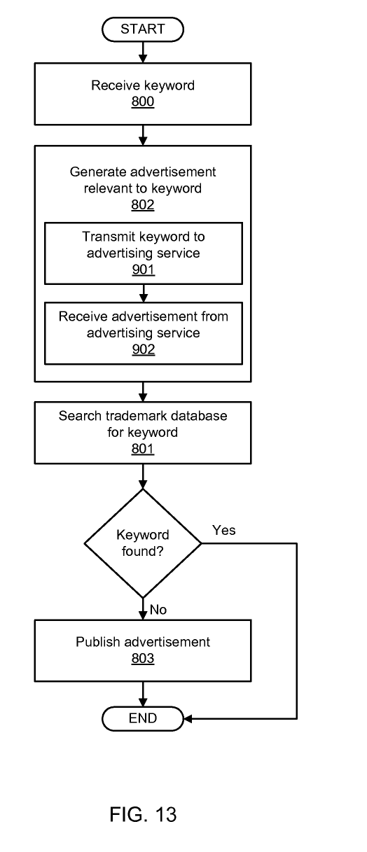

Another example embodiment of a method for filtering online advertisements containing third-party trademarks is illustrated in FIG. 13. In this example embodiment, a keyword 105 may be received (Step 800). An advertisement 107 then may be generated relevant to the keyword 105 (Step 802). A trademark database 102 then may be searched for the keyword 105 (Step 801). If the keyword 105 is not found in the trademark database 102, the advertisement 107 then may be published on a webpage 100 (Step 803). In this embodiment, the advertisement 107 may be generated by transmitting the keyword 105 to a third-party advertising service, such as GOOGLE ADSENSE AND ADWORDS, YAHOO! SEARCH MARKETING, or MICROSOFT ADCENTER (Step 901). An advertisement 107 then may be received back from the advertisement service (Step 902) and published on a webpage 100 (Step 803).

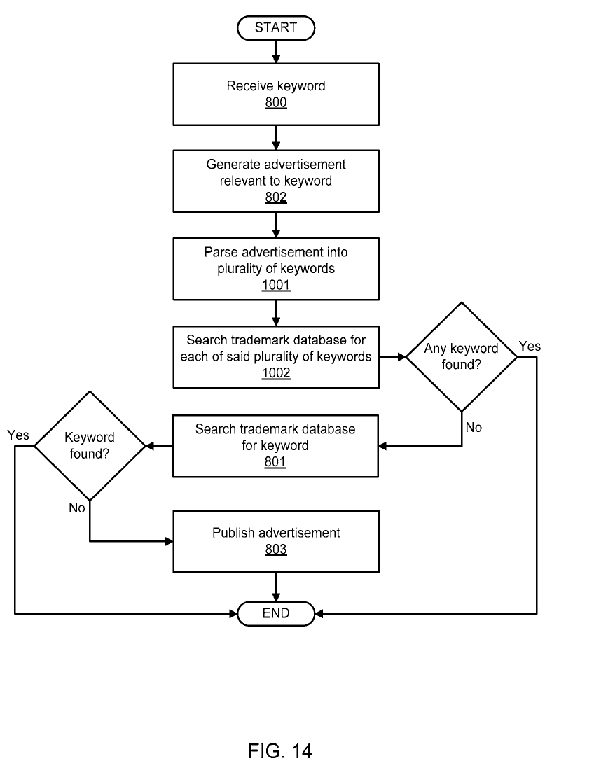

Another embodiment of a method for filtering online advertisements containing third-party trademarks is illustrated in FIG. 14. In this embodiment, which filters an advertisement 107 once generated, a keyword 105 is received (Step 800). An advertisement 107 is then generated relevant to the keyword 105. The advertisement 107 is then parsed into a plurality of keywords (Step 1001) perhaps using the parsing techniques discussed elsewhere in this application. The plurality of keywords may be generated from the content of the advertisement 107 (e.g., terms, links, and/or images appearing in the advertisement). The trademark database 102 is then searched for each of the plurality of keywords (Step 1002). If none of the plurality of keywords are found in the trademark database 102, the trademark database 102 then may be searched for the keyword 105 originally received in Step 800 (Step 801). If the keyword is not found in the trademark database, the advertisement 107 is published on a webpage 100 (Step 803).

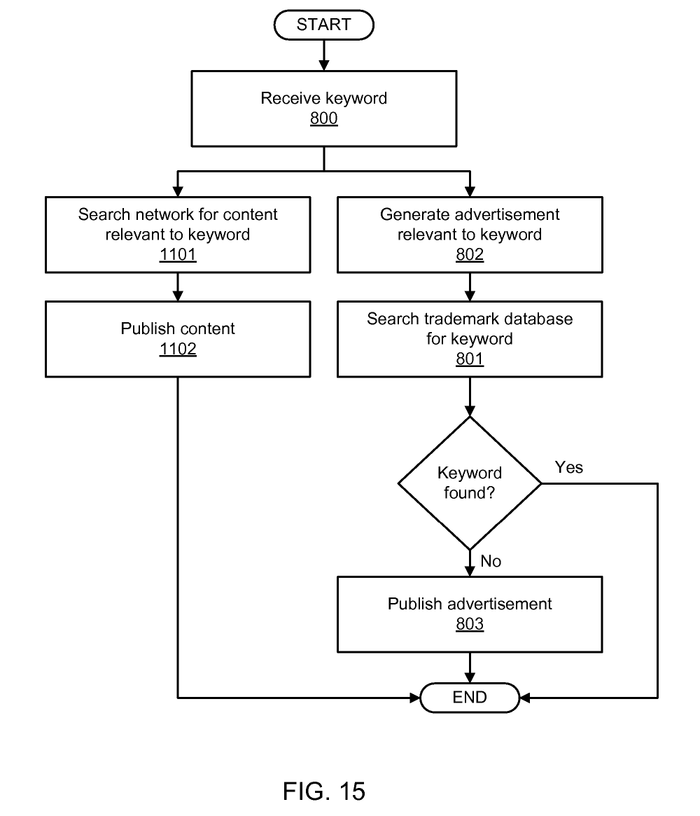

In another embodiment illustrated in FIG. 15, a keyword 105 may be received (Step 800). A network 109 then may be searched for content relevant to the keyword 105 (Step 1101). The embodiments illustrated herein place no limitation on network 109 configuration or connectivity. Thus, as non-limiting examples—and as illustrated in FIG. 3—the network 109 could comprise the Internet 301, an intranet 302, an extranet 303, a local area network 304, a wide area network 305, a wired network 306, a wireless network 307, a telephone network 308, or any combination thereof. The network 109 may be searched with any search engine known in the art and may use any of the search methodologies discussed above. The relevant content then may be published (Step 1102), perhaps via hyperlinks on a webpage 100. Concurrent with the above-described network content search, an advertisement 107 then may be generated relevant to the keyword 105. (Step 802). A trademark database 102 then may be searched for the keyword (Step 801). If the keyword 105 is not found in the trademark database 102 (Step 802), the advertisement 107 then may be published on the webpage 100 (Step 803) along with the above described content.

In yet another example embodiment, a customer may register a domain name with a registrar (the webpage host 101). Before the customer develops a fully-functional website, he may participate in his registrar's “domain parking” program to monetize his domain name, such as GODADDY.COM's CASHPARKING service. The registrar, who may partner with a third party advertising service (e.g., GOOGLE ADSENSE/ADWORDS) to provide advertising content, then may provide the customer with a “parked” webpage 100 to which his domain name may resolve. The trademark filter then may receive a keyword 105 from the registrar (Step 800). The keyword 105 may have been generated by parsing the customer's domain name. The registrar then may search its internally-stored plurality of data downloaded from the USPTO to determine whether the keyword 105 is absent from the USPTO' TESS 402 or TARR 403 trademark databases, for example. If the keyword 105 is not found, it then may be transmitted to an advertising service (Step 901). The advertising service then may generate an advertisement 107 relevant to the keyword (Step 802) by searching its internal inventory of advertisers for appropriate advertisements. The advertising service then may return the advertisement 107 to the registrar (Step 902). To further reduce the probability that the generated advertisement 107 does not contain trademarks, the registrar then may re-filter the advertisement 107 by generating additional keywords from the advertisement's 107 content by parsing the advertisement 107 into a plurality of keywords (Step 1001). The registrar then may re-search its internally-stored plurality of data downloaded from the USPTO to determine whether any of the plurality keywords are present in the USPTO' TESS 402 or TARR 403 trademark databases, for example. If none are found, the advertisement 107 relevant to the keyword 105 may be published on the customer's “parked” webpage 100 (Step 803). When Internet traffic clicks on the advertisement 107, the advertising service may pay a fee shared by the registrar and the customer.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system for filtering online advertisements containing third-party trademarks, comprising:
a) a webpage hosted by a webpage host;
b) a trademark database having a plurality of trademarks;
c) a check trademark service to determine the absence of a keyword in said trademark database;
d) an advertising generator generating an advertisement relevant to said keyword; and
e) an advertisement publisher publishing said advertisement on said webpage,
f) a network communicatively coupling said webpage host, said trademark database, said check trademark service, said advertising generator, and said advertising publisher.

2. The system of claim 1, wherein said keyword comprises a search term entered in a search engine, a parsed domain name, a parsed webpage content, or a parsed advertisement.

3. The system of claim 1, wherein said trademark database further comprises a collection of data maintained by the USPTO, the USPTO TESS database, the USPTO TARR database, a collection of data maintained by a third party, a trademark database maintained by a third party, a blacklist, or any combination thereof.

4. The system of claim 1, wherein said network comprises the Internet, an intranet, an extranet, a local-area network, a wide-area network, a wired network, a wireless network, a telephone network, or any combination thereof.

5. The system of claim 1, wherein said check trademark service further comprises:
i) a storage area;
ii) a data transfer service for downloading a plurality of data from said trademark database to said storage area; and
iii) a data search service to determine the absence of said keyword in said storage area.

6. The system of claim 3, wherein said plurality of trademarks has been optimized for searching for the presence of keywords.

7. A system for filtering online advertisements containing third-party trademarks, comprising:
a) means for receiving a keyword;
b) means for searching a trademark database for said keyword;
c) means for generating an advertisement relevant to said keyword if said keyword is not found in said trademark database; and
d) means for publishing said advertisement on a webpage.

8. The system of claim 7, wherein said keyword comprises a search term entered in a search engine, a parsed domain name, a parsed webpage content, or a parsed advertisement.

9. The system of claim 7, wherein said trademark database comprises a collection of data maintained by the USPTO, the USPTO TESS database, the USPTO TARR database, a collection of data maintained by a third party, a trademark database maintained by a third party, a blacklist, or any combination thereof.

10. The system of claim 7, wherein said network comprises the Internet, an intranet, an extranet, a local-area network, a wide-area network, a wired network, a wireless network, a telephone network, or any combination thereof.

11. The system of claim 7, wherein said means for searching a trademark database further comprises:
i) means for downloading a plurality of data from said trademark database;
ii) means for storing said plurality of data; and
iii) means for searching said plurality of data for said keyword.

12. The system of claim 7, wherein said plurality of data has been optimized for searching for the presence of keywords.

13. A method for filtering online advertisements containing third-party trademarks, comprising the steps of:
a) receiving a keyword;
b) searching a trademark database for said keyword;
c) if said keyword is not found in said trademark database, generating an advertisement relevant to said keyword; and
d) publishing said advertisement on a webpage.

14. The method of claim 13, wherein said keyword comprises a search term entered in a search engine, a parsed domain name, a parsed webpage content, or a parsed advertisement.

15. The method of claim 13, wherein said trademark database comprises a collection of data maintained by the USPTO, the USPTO TESS database, the USPTO TARR database, a collection of data maintained by a third party, a trademark database maintained by a third party, a blacklist, or any combination thereof.

16. The method of claim 13, wherein said generating an advertisement step further comprises the steps of:
i) transmitting said keyword to an advertising service; and
ii) receiving said advertisement from said advertising service.

17. A method of claim 13, further comprising the steps of, prior to step d):
i) parsing said advertisement into a plurality of keywords;
ii) searching said trademark database for each of said plurality of keywords; and
iii) if none of said plurality of keywords are found in said trademark database, proceeding to step d).

18. The method of claim 13, further comprising the steps of, subsequent to step a):
i) searching a network for a plurality of content relevant to said keyword, said network comprising the Internet, an intranet, an extranet, a local-area network, a wide-area network, a wired network, a wireless network, a telephone network, or any combination thereof; and
ii) publishing said plurality of content on a webpage.

19. A method for filtering online advertisements containing third-party trademarks, comprising the steps of:
a) receiving a keyword;
b) generating an advertisement relevant to said keyword;
c) searching a trademark database for said keyword; and
d) if said keyword is not found in said trademark database, publishing said advertisement on a webpage.

20. The method of claim 19, wherein said keyword comprises a search term entered in a search engine, a parsed domain name, a parsed webpage content, or a parsed advertisement.

21. The method of claim 19, wherein said generating an advertisement step further comprises the steps of:
i) transmitting said keyword to an advertising service; and
ii) receiving said advertisement from said advertising service.

22. The method of claim 19, wherein said trademark database comprises a collection of data maintained by the USPTO, the USPTO TESS database, the USPTO TARR database, a collection of data maintained by a third party, a trademark database maintained by a third party, a blacklist, or any combination thereof.

23. A method of claim 19, further comprising the steps of, prior to step c):
i) parsing said advertisement into a plurality of keywords;
ii) searching a trademark database for each of said plurality of keywords; and
iii) if none of said plurality of keywords are found in said trademark database, proceeding to step c).

24. The method of claim 19, further comprising the steps of, subsequent to step a):
i) searching a network for a plurality of content relevant to said keyword, said network comprising the Internet, an intranet, an extranet, a local-area network, a wide-area network, a wired network, a wireless network, a telephone network, or any combination thereof; and
ii) publishing said plurality of content on a webpage.

25. A method for filtering online advertisements containing third-party trademarks, comprising:
a) receiving at least one keyword, said keyword comprising a search term entered in a search engine, a parsed domain name, a parsed webpage content, or a parsed advertisement;
b) searching a network for a plurality of content relevant to said keyword, said network comprising the Internet, an intranet, an extranet, a local-area network, a wide-area network, a wired network, a wireless network, a telephone network, or any combination thereof;
c) publishing said plurality of content on a webpage;
d) searching a trademark database for said at least one keyword, said trademark database comprising a collection of data maintained by the USPTO, the USPTO TESS database, the USPTO TARR database, a collection of data maintained by a third party, a trademark database maintained by a third party, a blacklist, or any combination thereof, said searching step comprising the steps of: i) downloading a plurality of data from said trademark database, said plurality of data having been optimized for searching for the presence of keywords; ii) storing said plurality of data; and iii) searching said plurality of data for said at least one keyword;
e) if said at least one keyword is not found in said trademark database, generating an at least one advertisement relevant to said at least one keyword, said generating step comprising the steps of: i) sending said at least one keyword to an advertising service; and ii) receiving said at least one advertisement relevant to said at least one keyword from said advertising service;
f) parsing said at least one advertisement into a plurality of keywords;
g) searching said trademark database for each of said plurality of keywords, said searching step comprising the steps of: i) downloading a plurality of data from said trademark database, said plurality of data having been optimized for searching for the presence of keywords; ii) storing said plurality of data; and iii) searching said plurality of data for said at least one keyword; and
h) if none of said plurality of keywords are found in said trademark database, publishing said at least one advertisement on said webpage.
